(19) United States
(12) Patent Application Publication
(10) Pub. No.: US 2001/0034684 A1
(43) Pub. Date: Oct. 25, 2001

(54) System and methods for designing group retirement plans

(76) Inventors: James K. Cushing, Des Moines, IA (US); Michael J. Daugherty, Dunkerton, IA (US); Thomas J. Donnelly, Des Moines, IA (US); Angela M. Ellis, Norwalk, IA (US); Patricia M. Kliegl, Johnston, IA (US); William J. Kelly, Ankeny, IA (US); Kara M. Kohler, Johnston, IA (US); Richard L. Prey, Clive, IA (US); Troy G. Renken, Lindfield (AU)

Correspondence Address: ZARLEY MCKEE THOMTE VOORHEES & SEASE PLC, SUITE 3200, 801 GRAND AVENUE, DES MOINES, IA, 50309-2721, US

(21) Appl. No.: 09/819,318

(22) Filed: Mar. 28, 2001

Related U.S. Application Data
(60) Provisional application No. 60/192,833, filed on Mar. 29, 2000.

(51) Int. Cl. G06F 17/60

(52) U.S. Cl. 705/35

(57) ABSTRACT

The invention includes a new method and system for designing group retirement plans. The method and system merge a prospective plan sponsor's business objectives and needs with a business logic component for plan design. Based upon information collected from the plan sponsor, the business logic component designs a suitable group retirement plan. The present invention generally eliminates the need for a sales representative in retirement plan design.

### CROSS-REFERENCE TO RELATED APPLICATION

This application claims priority to U.S. Provisional Application Ser. No. 60/192,833 filed Mar. 29, 2000, entitled SYSTEM AND METHODS FOR DESIGNING GROUP RETIREMENT PLANS.

### BACKGROUND OF THE INVENTION

1. Field of the Invention

The present invention relates to financial services and retirement plans. More particularly, though not exclusively, the present invention relates to a system and methods for designing group retirement plans, eliminating the need for a sales representative in plan development by merging a plan sponsor's business objectives and needs directly with a business logic component for retirement plan design.

2. Problems in the Art

Employers today face a number of challenges in managing productivity and efficiency, including uncovering ways to reduce business taxes, keep employee benefit costs low, and hire and retain quality employees. Not surprisingly, many employers have turned to group retirement plans as part of a compensation package to attract quality employees while encouraging employee loyalty, thereby reducing the time employers spend hiring and training. A retirement plan can also help employers gain important tax advantages, as contributions and costs are deductible business expenses for many plan designs.

Although there are many types of retirement plans, all plans fall under one of two categories: qualified or nonqualified. Qualified plans meet the requirements of Section 401(a) of the Internal Revenue Service (IRS) Code and Regulations. By meeting these requirements, qualified plans offer immediate tax advantages to employers and their employees. Qualified plans are either defined contribution or defined benefit plans. Examples of qualified plans include profit sharing plans, money purchase plans, defined benefit pension plans, etc.

Nonqualified plans do not meet IRS Code Section 401(a) guidelines. Thus, these plans do not offer all of the tax advantages of qualified plans. However, nonqualified plans can be attractive because they offer more design flexibility, are relatively free of IRS requirements (reducing administrative costs), and may allow employers to offer additional benefits to a select group of employees.

Retirement plans can be customized to fit specific business needs. For example, employers seeking to attract new employees may adopt a plan eligibility rule where employees can join the plan immediately upon hire. Employers may also customize a plan with particular rules for vesting, employer matching contributions, investment options, loans, etc. Successful retirement plans are the result of good plan design; the plan rules should reflect the business objectives and needs of the employer and the needs of their employees.

Unfortunately, government regulations and guidelines concerning plan requirements are quite complicated. In the past, the financial services industry has relied on sales representatives to meet with prospective customers/employers to design a suitable retirement plan. The sales representative relies upon his or her knowledge of plan development and government regulations to design a plan consistent with the employer's business needs. Although this approach may be cost effective for large employers, it does not work well for small businesses. The administrative costs associated with plan design for employers with less than approximately one hundred employees is relatively high. This provides sales representatives and financial service companies little incentive to market group retirement products to small businesses. As a result, a large portion of the market is not effectively served. Thus, there developed a need in the art to provide a cost effective means to market and design group retirement plans to meet the needs of small businesses.

Within the last decade, the Internet has become a more commonly used form of communication. The Internet provides a convenient means for financial services companies to interact directly with customers. Others have used the Internet as a tool in retirement plan development, attempting to replace the sales representative. Such systems have several problems and deficiencies. Perhaps most significant, these systems assume the employer has an understanding of plan design and the significance of adopting specific plan rules. By way of example only, prior art systems may ask the employer through a Web-based application to select a specific rule such as a vesting schedule. However, it is likely that the employer will fail to appreciate the effect of selecting one rule over another. Consequently, the employer may select rules for the plan that contradict the employer's business needs and objectives. A need therefore still exists in the art for a cost effective means to market and design group retirement plans to meet the business needs of small businesses.

Many of the same problems exist in marketing retirement plans to not-for-profit organizations, as well as Taft-Hartley, or multi-employer, benefit plans. Accordingly, the present invention is not intended solely for use by for-profit employers, but other types of organizations too.

3. Features of the Invention

A general feature of the present invention is the provision of a system and methods which overcome the problems and deficiencies found in the prior art.

A further feature of the present invention is the provision of a financial services system that eliminates the need for a sales representative in retirement plan design.

A further feature of the present invention is the provision of a financial services system that merges a plan sponsor's business needs and objectives with retirement plan development.

A further feature of the present invention is the provision of a new system for designing group retirement plans that is driven by business needs and goals.

A still further feature of the present invention is the provision of a new system for designing group retirement plans that determines whether an organization can effectively use the system and methods discussed herein, eliminating the need for normal underwriting services.

Another feature of the present invention is the provision of a new system for designing group retirement plans that reduces administrative costs.

Yet another feature of the present invention is the provision of a new system for designing group retirement plans that allows prospective plan sponsors to view recommended plan rules and modify such rules.

Another feature of the present invention is the provision of a new system for designing group retirement plans that informs the prospective plan sponsors about the effect of modifying recommended plan rules.

Another feature of the present invention is the provision of a new system for designing group retirement plans that generates in ready to execute form the application, service agreement, and plan adoption documents for the plan.

Another feature of the present invention is the ability to execute an application for a plan contract, service agreement and plan adoption documents electronically, including signature and payment.

These as well as other features and advantages of the present invention will become apparent from the following additional disclosure.

### SUMMARY OF THE INVENTION

The present invention includes a new method and system for designing group retirement plans, eliminating the need for a sales representative in retirement plan design. The method and system merge a plan sponsor's business objectives and needs directly with a business logic component for retirement plan design. Based upon information collected from the prospective plan sponsor, the business logic component designs a suitable group retirement plan. In its preferred form, the present invention is implemented over a computer network, such as an open computer network like the Internet, using a Web site system and Web-based applications.

Another aspect of the present invention is a system and method for providing the plan sponsor the ability to modify recommended plan rules. The plan sponsor may also be provided with information concerning the consequences of making specific modifications to a recommended plan.

In another aspect of the present invention, a plurality of investment options are selected for the plan based upon the goals and objectives of the plan sponsor. That is, a business driver focus is applied to the selection of investment options available to plan participants.

Another aspect of the invention is a means and method of performing an eligibility check to determine, prior to any plan design work, whether a prospective plan sponsor may effectively design a group retirement plan using the system. In this mode, the system acts as an underwriter, determining whether the potential plan sponsor meets the criteria for use the system to design a plan eligibility.

Yet another aspect of the present invention is a means and method for generating an application, contract and service agreement for the group retirement plan. Execution of the application, plan contract and service agreements may be done electronically, including signature and payment.

Those skilled in the art will recognize additional aspects of the present invention from a detailed description of an exemplary embodiment that follows.

### BRIEF DESCRIPTION OF THE DRAWINGS

The present invention is illustrated by way of example and not limitation in the figures of the accompanying drawings, and in which:

FIG. 1 is a functional block diagram of Web-based data processing system for designing group retirement plans according to a preferred embodiment of the present invention.

FIGS. 2-5 are a procedural flow chart illustrating the Web site processing performed by the Web-based data processing system.

FIG. 6 is a chart illustrating the underwriting logic of the preferred embodiment.

FIG. 7 is a chart illustrating the retirement plan design logic of the preferred embodiment.

FIGS. 8-11 are illustrations of a Web browser displaying representative Web pages of the preferred embodiment.

### DETAILED DESCRIPTION OF A PREFERRED EMBODIMENT

The present invention will be described as it applies to its preferred embodiment. It is not intended that the present invention be limited to the described embodiment. It is intended that the invention cover all modifications and alternatives which may be included within the spirit and broad scope of the invention.

The preferred embodiment is directed to a system for designing a 401(k) retirement plan, a popular defined contribution retirement plan. Those skilled in the art will recognize that the system and methods disclosed as part of the preferred embodiment can be easily adapted for other types of retirement plans, both qualified and nonqualified plans.

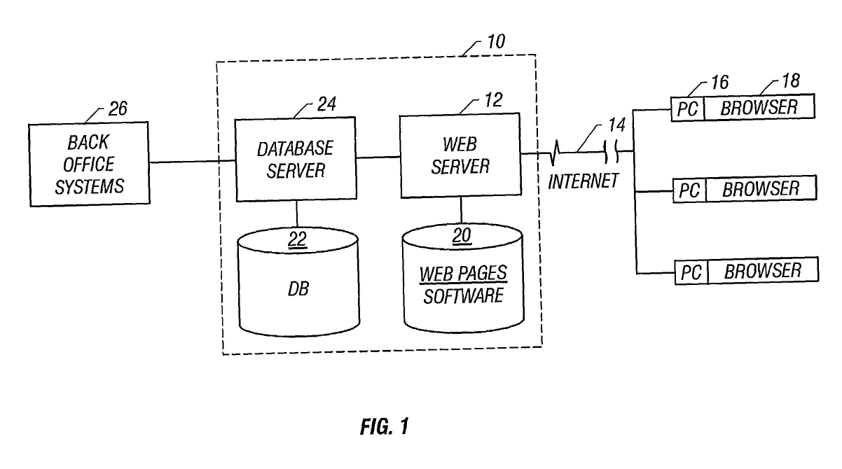

The preferred embodiment utilizes traditional Internet Web-based architecture. FIG. 1 illustrates the logical architecture of the preferred embodiment in a functional block diagram. The Web site system 10 provides various functionality for designing and marketing group retirement plans. Web server 12 is connected to a computer network, such as the Internet 14. Other computer networks suitable for use with the present invention include, but are not limited to, a LAN, a WAN, an Intranet, and an Extranet. A plurality of end-user data processing systems 16 with Web browsers 18 are connected to the Internet 14. Web browsers 18 are client software programs based upon HTTP (Hyper-Text-Transfer-Protocol) compatible products, such as Netscape Navigator, JAVA Browser or Microsoft Internet Explorer. Web pages and Web application software are loaded on a storage medium 20 accessible to the Web Server 12. Retirement plan data and plan sponsor data is stored on a storage medium 22 serviced by a database server 24. The precise operating systems and hardware configurations of the database server 24, Web server 12, and Web browsers 18 are not limited to any specific hardware or software configuration. These systems can be implemented on a wide variety of hardware and software platforms.

A system in accordance with the present invention may interface to corporate back-office applications. Database server 24 is coupled via a link to corporate back-office systems 26, commonly on mainframe systems running back-office applications. Customized application procedural interfaces (APIs) are generally used to accomplish the back-office communication.

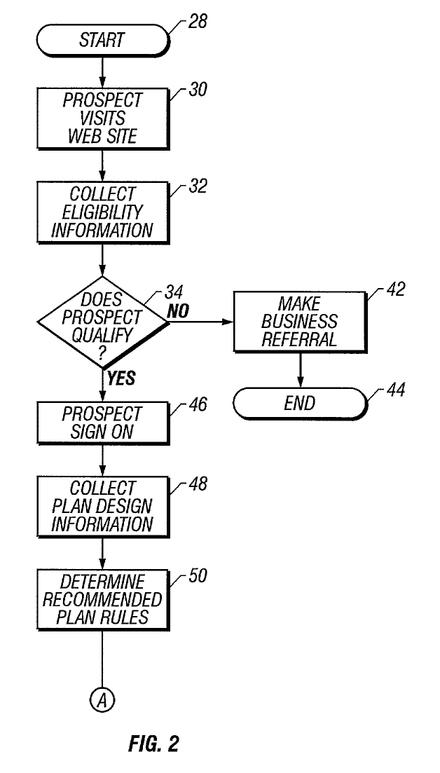

As described briefly above, the Web site system 10 includes software and Web pages that implement the design and sale of group retirement plans. FIGS. 2-4 illustrate the operation and logic of the system in a procedural flow chart. Referring to FIG. 2, the process begins at steps 28, 30 when a prospective plan sponsor visits the Web site. The prospect's Web browser 18 through the Internet 14 communicates with the Web server 12 during this session.

At step 32 the prospect enters information about the prospect's business into an electronic template. Information is gathered necessary to determine whether the prospect qualifies to purchase an annuity contract and to design and adopt a 401(k) plan through the Web site 10. For example, the financial services provider could decide to offer the Web site service only to organizations having less than 100 plan participants and who are committed to using a totally electronic 401(k) plan. The appropriate questions can then be asked to screen potential plan sponsors for the Web site service. Of course, requirements for eligibility will vary from one financial services provider to another, depending on the segment of the market targeted. However, in addition to basic contact information, responses to the following list of questions have been found helpful in determining whether a particular prospect qualifies:

In what state does the person setting up the plan work?

What type of business (e.g., sole proprietorship, S-Corporation, C-Corporation, not-for-profit) does the plan sponsor operate?

Does the plan sponsor currently offer a retirement plan to its employees? And if so, what type?

Does the plan sponsor want to continue with an existing plan?

What type of retirement plan does the plan sponsor want?

How many employees does the plan sponsor have?

Is the plan sponsor willing to contribute to its employee's retirement?

Is the plan sponsor committed to a self-serve, totally electronic retirement plan?

Are plan participants expected to contribute towards their retirement benefit?

Should the plan sponsor's contribution to the plan participant's accounts be flexible or a stated amount?

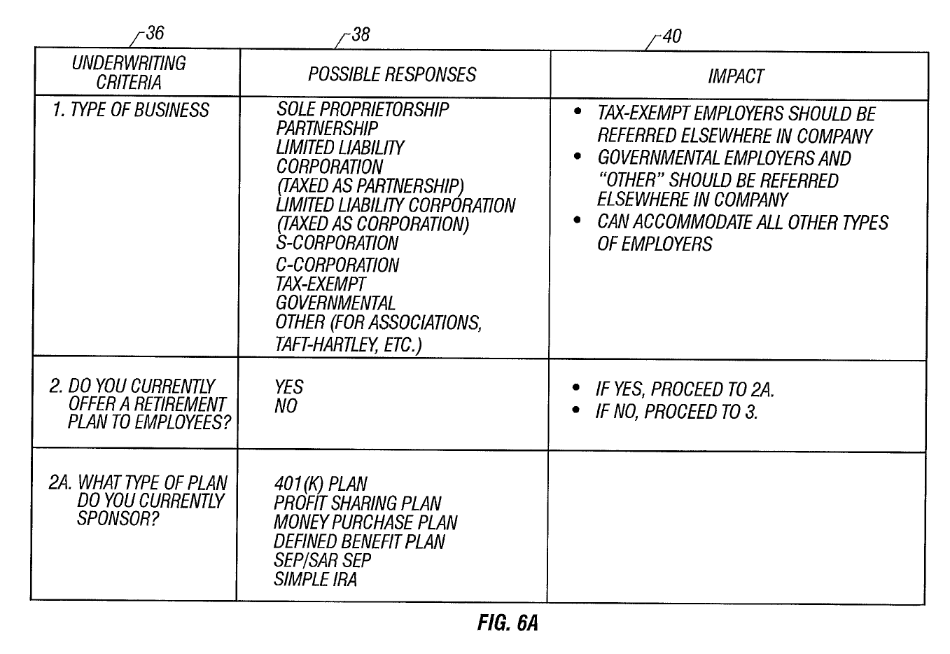

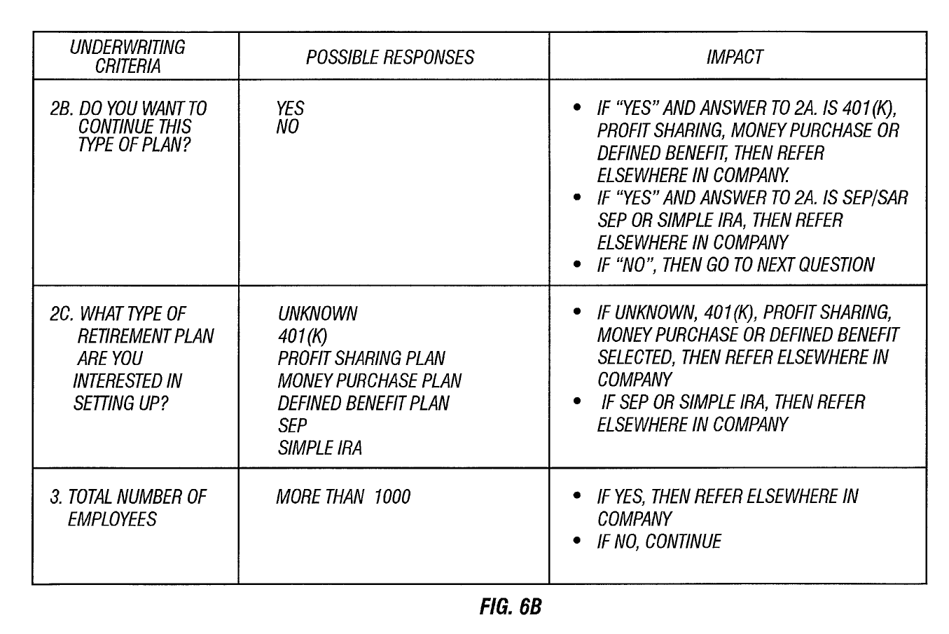

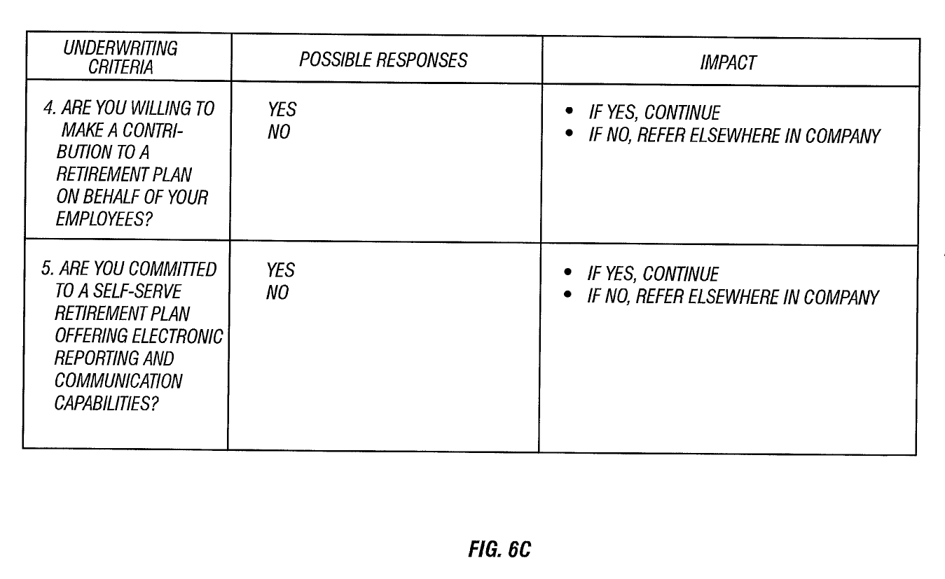

FIG. 6 illustrates the logic in determining whether the prospect qualifies at step 34 based upon responses to the questions set forth above. The underwriting criteria or questions are provided in column 36, the possible responses in column 38, and impact of the possible responses in column 40. For instance, if the prospect/plan sponsor is a governmental agency, it would not qualify. Instead, the prospect would be referred elsewhere in the company for service. As another example, the prospect would not qualify to use the Web site service if it employed more than 1,000 people. These are examples only. Of course, the methods and systems disclosed as part of the preferred embodiment could be easily adapted to include governmental agencies and organizations having more than 1,000 people.

FIG. 6 provides logic behind the underwriting criteria. In the preferred embodiment, this logic is intended to identify small to medium sized plan sponsors who are, among other things, committed to an electronic plan administration system. Again, the screening or underwriting criteria can be easily modified by the financial services provider as necessary.

Based upon the rules and logic described above, a determination is made at step 34 as to whether the prospect is a match for or qualifies to use the Web site service. If the prospect is not a match for the service, then the prospect is referred to another part of the company (steps 42, 44). If the prospect is a match, then the prospect proceeds to “sign on” to the Web site at step 46. The prospect provides a user name and personal identification number (PIN) when signing on for the first time. The user name and PIN has several purposes. First, information entered about the plan sponsor can be saved and easily accessed later should the prospect leave the Web site before purchasing a plan. Second, requiring a user name and PIN provides a level of security for the private data which will be required to set up the plan design, contract application and service application. Further, the user name and PIN can constitute an electronic signature for executing documents.

Once the prospect has successfully signed on to the Web site, plan design information is collected from the prospect at step 48. In a preferred form of the invention, the plan design information, at least in part, relates to the business objectives and/or needs of the plan sponsor. Good plan design includes selecting plan rules that meet the needs of the plan sponsor. Prior art systems have suffered from a total inability to merge the plan sponsor's business objectives or goals with the plan design process. Asking the prospect to select a vesting schedule or a percentage for matching employer contributions generally accomplishes very little in designing a plan consistent with the plan sponsor's business objectives. Most plan sponsors do not appreciate the business consequences, for example, of selecting one vesting schedule over another. For this reason, the preferred embodiment of present invention gathers information about the plan sponsor's business objectives or goals, and then translates those objectives into a recommended set of plan rules. Thus, the present invention effectively eliminates the need for a sales representative in the plan design process through a consideration of the plan sponsor's business drivers.

Plan rules relating to participant eligibility, participant contribution amounts, profit sharing contributions, vesting of plan sponsor contributions, and loans and withdrawals offered under the retirement plan can be customized for a particular plan sponsor. This list of parameters or rules is exemplary only, and is not meant to be limiting. However, it has been found that defined contribution retirement plans can be effectively designed for most plan sponsors with proper consideration given to these parameters.

In a preferred embodiment, the prospect is asked the following questions at step 48:

1. Why do you want to set up a retirement plan? (Select two)

To attract new employees

To retain existing employees

To compensate higher-paid employees

To reduce tax liability

2. Who should benefit most from the retirement plan? (Select one)

All employees

Only those employees who have completed some service with the company

3. Do you want your employees to be able to borrow from their retirement accounts?

This list of questions is not exhaustive, and can be supplemented and modified as necessary. With answers to these questions, a determination of recommended plan rules can be made at step 50. To make this determination, computer software follows a set of predefined business logic rules.

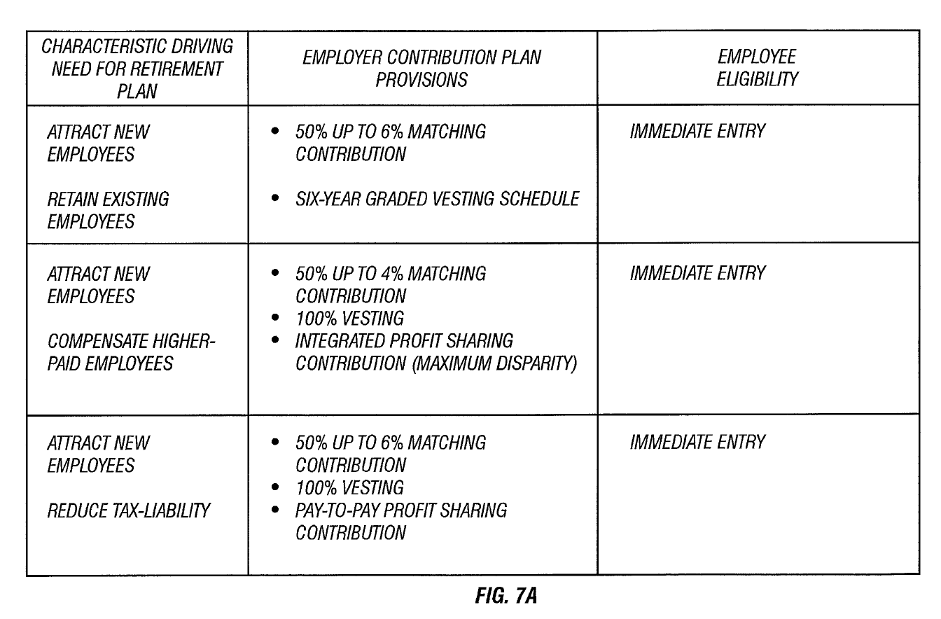

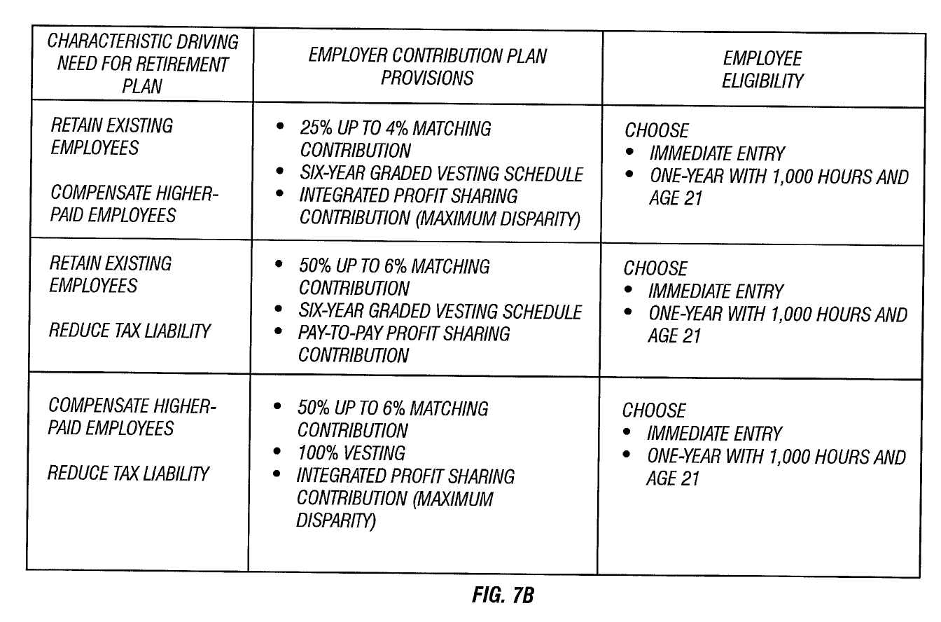

FIG. 7 shows the logic for determining plan rules concerning participant eligibility and participant contributions, including the amount of the contributions and a vesting schedule. The characteristics driving the need for a retirement plan (answer to question #2 above) are shown in column 52, the plan sponsor contribution plan provisions are in column 54, and participant eligibility provisions are in column 56. To illustrate one possible scenario, if the prospect identified as reasons for setting up a plan “to attract new employees” and “to retain existing employees” (see FIG. 7, row 1) then the system would recommend that the employer provide a 50% matching contribution up to 4% of the employee's annual compensation. In addition, the system would recommend a six-year graded vesting schedule and that employees be eligible to participate upon hire. As another illustration, if the business drivers are “to compensate higher-paid employees” and “to reduce tax liability” (see FIG. 7, row 6), the system would still recommend a 50% matching contribution up to 4% of the employee's salary. However, the employer's contributions would immediately vest, and an integrated profit sharing contribution would also be provided. Further, the prospect would be given the option to select either “immediate entry” or “one year with 1,000 hours and age 21” with respect to employee or participant eligibility.

As for whether loans are offered under the plan, this is dictated by the prospect's answer to the loan question (#3) above. The system could easily be modified to also ask the prospect whether an objective is to provide participants access to their accounts before retirement, such as through hardship or in-service withdrawals.

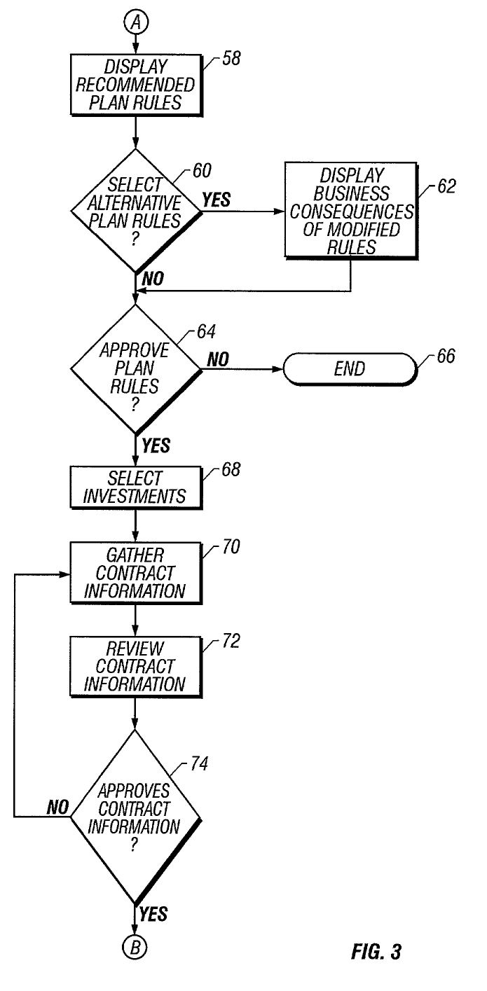

Next, the recommended plan rules or provisions are returned to the prospect's Web browser 18 at step 58 (see FIG. 3). At this point, the prospect can review the recommended plan rules and any alternative plan rules available through the system. For instance, the system may recommend a six-year vesting schedule, but also present the prospect with alternative vesting schedules. If the prospect selects an alternative plan rule at step 60, then the system displays the business consequences of the change at step 62. For example, if the prospect selects a longer vesting schedule, the system would inform the prospect as to the potential negative impact in attracting new hires.

At step 64, the prospect ultimately either approves the plan rules or, for whatever reason, decides not to purchase a plan (step 66). Once the prospect has approved the plan rules, the prospect proceeds to select one or more investment options offered to participants under the plan (step 68). These investments may include individual securities, mutual funds, money market accounts, etc. The investments may also include individual securities in separate accounts.

Next, the system begins building the actual plan contract by first querying the prospect for more information at step 70, particularly information necessary to prepare an application for a retirement plan contract. Such information may include the full legal name of the plan sponsor, the employer identification number (EIN), date of incorporation/establishment, standard industry code (SIC), person with legal authority to bind the plan sponsor, and the frequency of contributions (e.g., weekly, monthly). The prospect reviews and approves the contract information at steps 72 and 74, respectively.

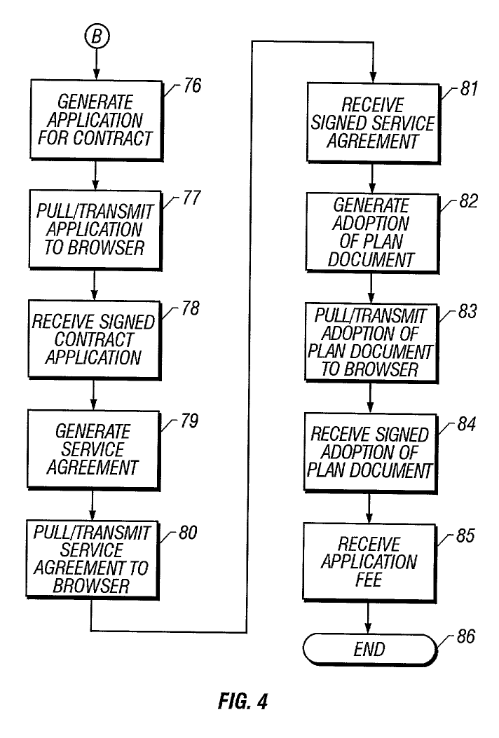

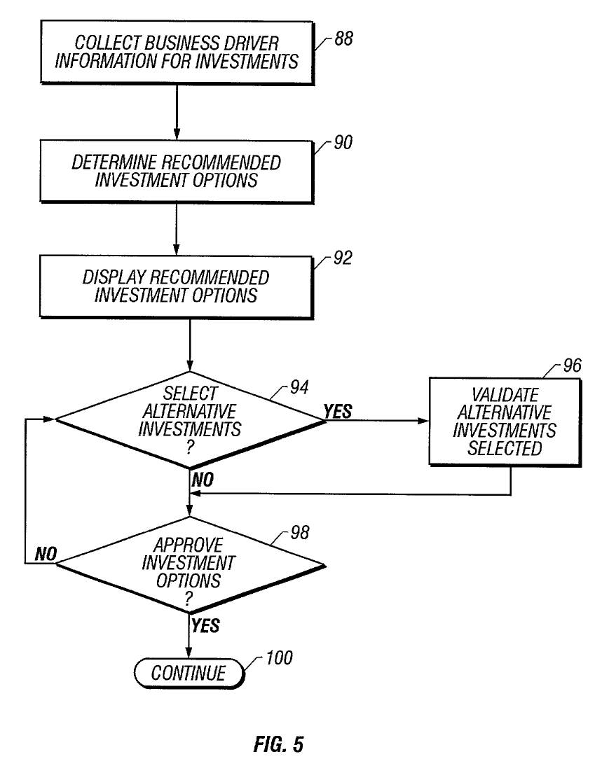

Based upon the contract information and the approved plan rules, the system assembles an application for a contract, which is an electronic document (see step 76 in FIG. 4). Preferably, the application is “pulled” or transmitted to the prospect's Web browser 18 at step 77.

After reviewing the application, the prospect executes the application using an electronic signature. The system receives the signed contract application at step 78.

An electronic signature is an electronic manifestation of an intent to agree, and can include such things as typing a name at the bottom of a document, user names and passwords, voice-print recognition, and public key cryptography (digital signatures). The preferred form of electronic signature for use with the present invention is a username and password. The specific type of electronic signature may depend upon the applicable contract laws, however.

The system also generates and transmits a service agreement in electronic form to the prospect at steps 79 and 80, respectively. The prospect electronically signs the service agreement and the same is received on the system at step 81. The same process is repeated for the adoption of a plan document at steps. 82-84.

The process ends at steps 85, 86 with receipt of an application fee, preferably by means of an electronic funds transfer (EFT).

Note that the steps outlined as part of the preferred embodiment is FIG. 4 are exemplary only. For example, the contract application and the service agreement could be transmitted to the prospect at the same time. Further, certain of the documents could be sent to the prospect for a traditional “wet” signature.

Returning now to the selection of investments (step 68, FIG. 3), in its preferred form the present invention recommends to the plan sponsor one or more investment options that would be available to participants under the plan. The different investment options are recommended based upon the plan sponsor's business objectives and goals. As such, the selection of investment options has a business driver focus.

As shown in the flow chart in FIG. 5, business driver information is selected from the prospective plan sponsor at step 88. In a preferred embodiment, the prospect is asked one or more of the following questions at step 88:

1. Would you like to offer more than six investment options to your plan members?

2. If so, how many investment options would you like to offer? You may offer up to ten.

3. Would you prefer to add investment options that are considered lower risk or higher risk?

4. Would you like to have more than one investment option that invests in international stocks?

Based on the answers to these questions, a business logic component determines recommended investment options at step 90. In particular, the prospect is classified into one of three categories of pre-selected investments. These categories include (1) low risk investments with one international option, (2) high risk investments with one international option, and (3) high risk investments with two international options. Such pre-selected investments may include a variety of different types of financial instruments, including, but not limited to, stocks, mutual funds, and money market accounts.

The business logic used to classify a prospect into one of the above-enumerated categories is best illustrated by two specific examples. In the first, the prospect answers “no” to question #1, i.e., the prospect does not want more than six investment options. In this case, the prospect is directed into the “low risk investment with one international option” category. In a second example, the prospect enters “yes” to question #1. Based upon the number of investments selected in response to question #2, the system counts down the appropriate number of investments in preselected tables of investments for each category. If the prospect answers “lower risk” to question #3, then the prospect is directed into the low risk category. Otherwise, the appropriate high risk category is selected based upon the prospect's response to question #4.

The recommended investment options are displayed at step 92. The prospect then has an opportunity to review the specific investment options recommended and, if desired, select alternative investments at step 94. Any alternative investments selected by the prospect are validated at step 96. For example, the financial services provider may want to require at least one investment option in certain investment risk categories. The prospect ultimately approves the list of investment options at step 98 and the plan design process continues (step 100).

Those skilled in the art will appreciate that selecting investments based upon the business objectives and needs of the prospect can be implemented in various forms. The preceding illustration is exemplary only. Important is that the investment options are determined by business drivers, obviating the need for the prospect to fully appreciate or understand the consequences of selecting one investment portfolio over another.

Those skilled in the art will appreciate that the functionality described above can be implemented using HTML pages in combination with other software, such as JAVA or JAVA applets.

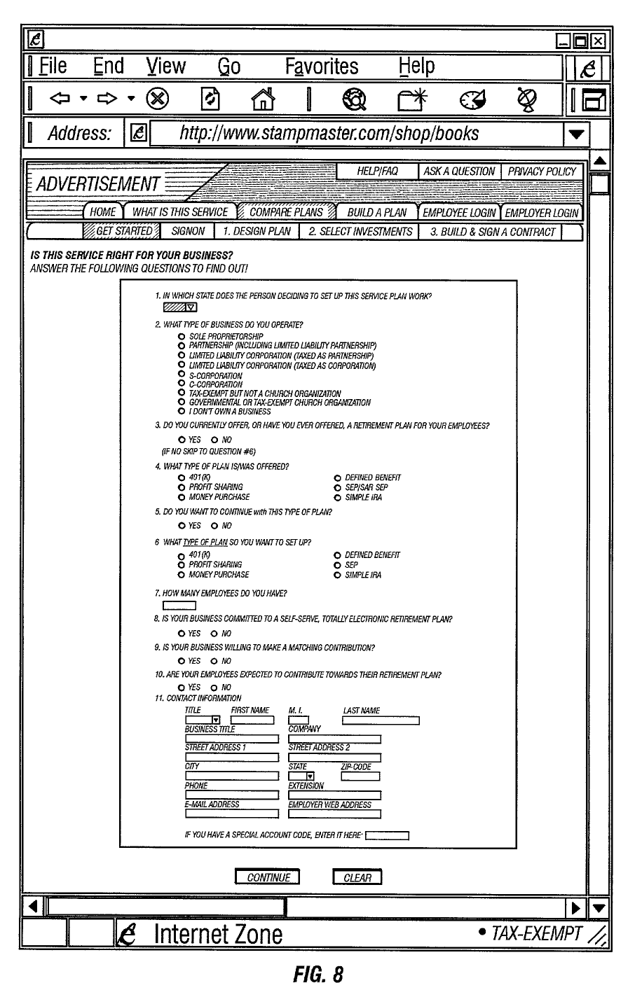

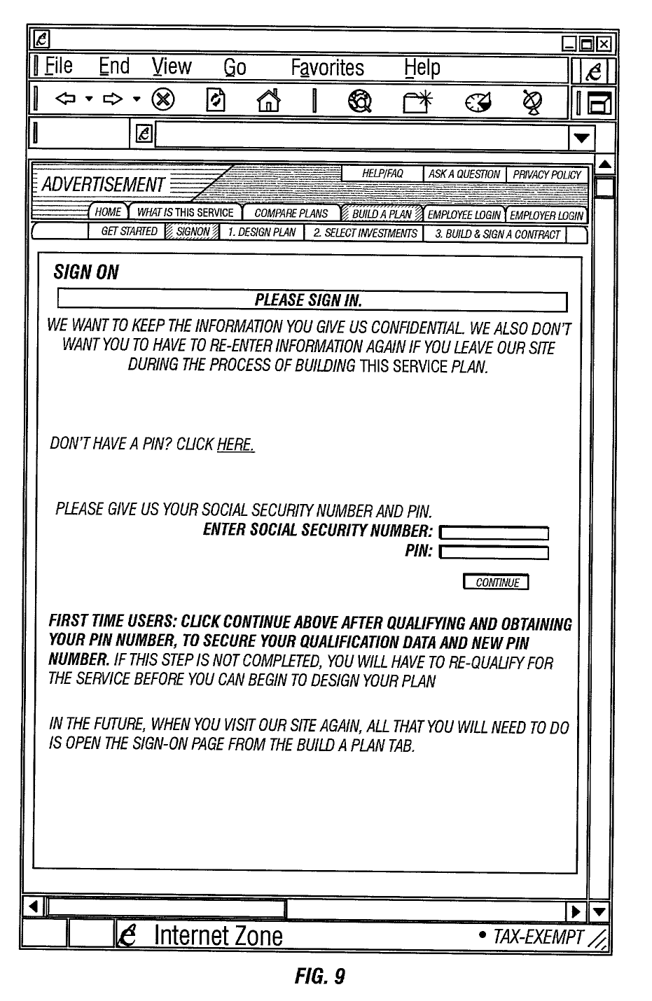

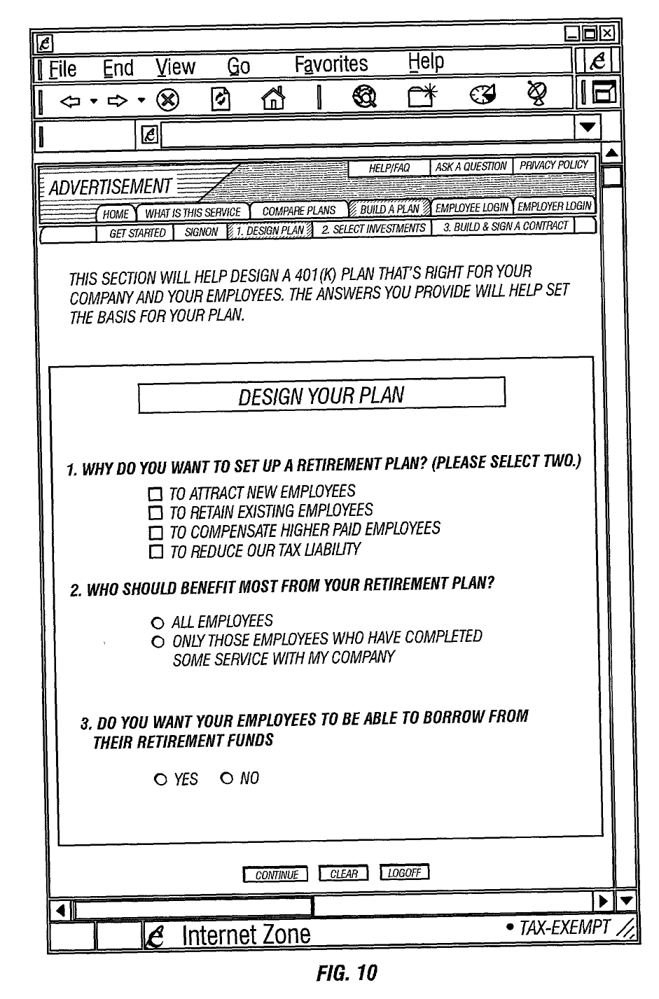

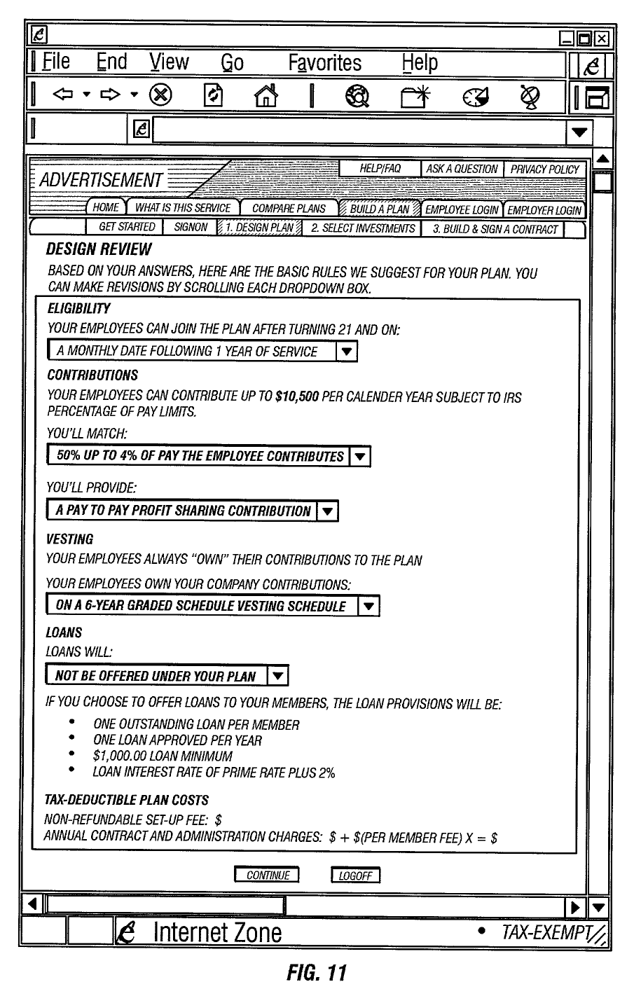

FIGS. 8-11 are illustrations of a Web browser 18 displaying representative Web pages of the preferred embodiment. In specific, FIG. 8 shows a Web page for collecting information from the prospect for underwriting/eligibility purposes. FIG. 9 is an exemplary sign on page. The Web page shown in FIG. 10 is intended for gathering design plan information from the prospect. Finally, the Web page shown in FIG. 11 is an example of recommended plan rules presented to the prospect for review. Note that the particular plan provisions in FIG. 11 are shown in drop-down boxes. The other entries in the drop-down boxes are alternative plan provisions. These Web pages are exemplary only, and can be customized as necessary for a particular application. Those skilled in the art to which the invention pertains will recognize alternative ways of collecting and presenting information.

A general description of the present invention as well as a preferred embodiment of the present invention has been set forth above. Those skilled in the art to which the present invention pertains will recognize and be able to practice additional variations in the methods and systems described and disclosed which fall within the broad teachings of this invention. Accordingly, all such modifications and additions are deemed to be within the scope of the invention.

What is claimed is:

1. A new method for designing group retirement plans for prospective plan sponsors, eliminating the need for a sales representative in retirement plan design, the method comprising:
providing a Web site hosted by at least one computer in communication with a computer network, the Web site having a business logic component for merging a plan sponsor's business needs with retirement plan design;
collecting information from the plan sponsor through the Web site, the information relating to the plan sponsor's business objectives;
analyzing the information using the business logic component; and
generating a retirement plan with plan rules appropriate to the plan sponsor's business objectives.

2. The method of claim 1 wherein the computer network is a wide area network.

3. The method of claim 1 wherein the computer network is the Internet.

4. The method of claim 1 wherein the group retirement plan is a defined contribution retirement plan.

5. The method of claim 1 wherein the information relating to the plan sponsor's business objectives includes one or more reasons of the plan sponsor for providing the retirement plan.

6. The method of claim 5 wherein the one or more reasons for providing the retirement plan include attracting and retaining employees.

7. The method of claim 1 wherein the information relating to the plan sponsor's business objectives includes an identification of plan participants intended to benefit under the retirement plan.

8. The method of claim 1 wherein the information relating to the plan sponsor's business objectives includes participant access to retirement accounts before retirement.

9. The method of claim 1 wherein at least one of the plan rules relates to plan participant eligibility.

10. The method of claim 1 wherein at least one of the plan rules relates to plan sponsor contribution amounts under the retirement plan.

11. The method of claim 1 wherein at least one of the plan rules relates to profit sharing contributions under the retirement plan.

12. The method of claim 1 wherein at least one of the plan rules relates to vesting of participant contributions under the retirement plan.

13. The method of claim 1 wherein at least one of the plan rules relates to loans offered under the retirement plan.

14. The method of claim 1 wherein the plan rules relate to participant eligibility, plan sponsor contribution amounts, vesting of plan sponsor contributions, and loans offered under the retirement plan.

15. The method of claim 1 further comprising the step of presenting to the plan sponsor one or more of the plan rules for review by the plan sponsor.

16. The method of claim 15 further comprising the step of facilitating a selection of one or more alternative plan rules by the plan sponsor.

17. The method of claim 16 further comprising the step of presenting to the plan sponsor one or more business consequences corresponding to the selection of the one or more alternative plan rules.

18. The method of claim 1 further comprising the step of generating an application for a retirement plan contract based upon the plan rules.

19. The method of claim 18 further comprising the step of electronically transmitting to the plan sponsor the application.

20. The method of claim 19 wherein the application is adapted to be executed and electronically submitted by the plan sponsor to apply for the retirement plan contract.

21. The method of claim 18 further comprising the step of generating a service agreement for the retirement plan.

22. The method of claim 21 further comprising the step of electronically transmitting to the plan sponsor the service agreement.

23. The method of claim 22 wherein the service agreement is adapted to be executed and electronically submitted by the plan sponsor.

24. The method of claim 20 further comprising the steps of generating an adoption of plan document.

25. The method of claim 24 further comprising the step of electronically transmitting to the plan sponsor the adoption of plan document.

26. The method of claim 25 wherein the adoption of plan document is adapted to be executed and electronically submitted by the plan sponsor.

27. The method of claim 1 further comprising the steps collecting information from the plan sponsor relating to the plan sponsor's business and evaluating the information to determine whether the plan sponsor is eligible for the retirement plan design via the Web site.

28. The method of claim 5 further comprising the step of facilitating a selection by the plan sponsor of one or more investment options for participants under the defined contribution retirement plan.

29. A new method for designing group retirement plans that is driven, at least in part, by the business objectives or goals of a plan sponsor, the method comprising:
collecting information about a prospective plan sponsor from a Web site hosted by at least one computer in communication with a computer network accessible to the prospective plan sponsor;
defining a set of eligibility rules for plan sponsors using the Web site for retirement plan design;
determining whether the plan sponsor is eligible to apply for a group retirement plan using the Web site based upon the collected information about the employer and the set of eligibility rules;
if the prospective plan sponsor is eligible for a group retirement plan design using the Web site, then performing the following:
collecting information from the plan sponsor relating to the business objectives of the plan sponsor;
defining a set of plan design rules correlating business objectives with retirement plan design,
evaluating the information relating to the business objectives of the plan sponsor using the plan design rules,
generating a plurality of retirement plan rules appropriate to the business objectives of the plan sponsor, and
presenting the retirement plan rules to the plan sponsor using the Web site.

30. The method of claim 26 wherein the computer network is the Internet.

31. The method of claim 29 wherein the group retirement plan is a defined contribution retirement plan.

32. The method of claim 29 wherein the group retirement plan is a defined benefit retirement plan.

33. The method of claim 29 wherein the retirement plan is a qualified plan.

34. The method of claim 29 wherein the retirement plan is a non-qualified plan.

35. The method of claim 29 wherein the information relating to the business objectives of the plan sponsor includes one or more reasons of the plan sponsor for providing the retirement plan.

36. The method of claim 29 wherein the information relating to the business objectives of the plan sponsor includes an identification of participants intended to benefit under the retirement plan.

37. The method of claim 29 wherein the information relating to the business objectives of the plan sponsor includes participant access to amount balances prior to retirement.

38. The method of claim 29 wherein at least one of the retirement plan rules relates to participant eligibility.

39. The method of claim 29 wherein at least one of the retirement plan rules relates to plan sponsor contribution amounts under the retirement plan.

40. The method of claim 29 wherein at least one of the retirement plan rules relates to profit sharing contributions under the retirement plan.

41. The method of claim 29 wherein at least one of the retirement plan rules relates to vesting of plan sponsor contributions under the retirement plan.

42. The method of claim 29 wherein at least one of the plan rules relates to loans or withdrawals offered under the retirement plan.

43. The method of claim 29 wherein if the perspective plan sponsor is eligible to apply for a group retirement plan using the Web site, then further comprising the step of facilitating a selection of one or more alternative plan rules by the plan sponsor.

44. The method of claim 43 wherein if the prospective plan sponsor is eligible to apply for a group retirement plan using the Web site, then further comprising the step of presenting to the plan sponsor one or more business consequences corresponding to the selection of the one or more alternative plan rules selected by the plan sponsor.

45. The method of claim 44 wherein if the prospective plan sponsor is eligible to apply for a group retirement plan using the Web site, then further comprising the step of generating an application for a retirement plan contract based upon the plan rules approved by the plan sponsor.

46. The method of claim 45 wherein if the prospective plan sponsor is eligible to apply for a group retirement plan using the Web site, then further comprising the step of transmitting the application to the plan sponsor via the Web site.

47. The method of claim 46 wherein the application is adapted to be electronically submitted by the plan sponsor to apply for the retirement plan contract.

48. The method of claim 44 wherein if the prospective plan sponsor is eligible to apply for a group retirement plan using the Web site, then further comprising the step of generating a service agreement for the retirement plan.

49. The method of claim 48 wherein if the prospective plan sponsor is eligible to apply for a group retirement plan using the Web site, then further comprising the step of transmitting the service agreement to the plan sponsor via the Web site.

50. The method of claim 49 wherein the service agreement is adapted to be executed and electronically submitted by the plan sponsor.45.

51. The method of claim 31 wherein if the prospective plan sponsor is eligible to apply for a group retirement plan using the Web site, then further comprising the step of facilitating a selection by the employer of one or more investment options for participants under the defined contribution retirement plan.

52. A first ever Web site system for designing group retirement plans for prospective plan sponsors over a computer network, the Web site system comprising:
a computer in communication with the computer network;
a Web page accessible over the computer network for receiving information about the plan sponsor, the information including one or more business objectives of the plan sponsor; and
software executing on the computer for determining retirement plan rules based, at least in part, upon the one or more business objectives of the plan sponsor.

53. The Web site system of claim 52 further comprising software executing on the computer for preparing a first electronic document which is an application to purchase a group retirement plan based upon the retirement plan rules.

54. The Web site system of claim 52 further comprising software executing on the computer for providing the plan sponsor the option of selecting alternative retirement plan rules.

55. The Web site system of claim 53 wherein the first electronic document is adapted to be electronically submitted by the plan sponsor.

56. The Web site system of claim 52 further comprising software on the computer for determining whether the prospective plan sponsor is eligible to purchase a retirement plan using the Web site system.

57. The Web site system of claim 53 further comprising software executing on the computer for preparing a second electronic document which is a service agreement for the retirement plan.

58. The Web site system of claim 57 wherein the second electronic document is adapted to be executed and electronically submitted by the plan sponsor.

59. A new method for designing group retirement plans for prospective plan sponsors, the method comprising:
providing at least one computer in communication with a computer network;
collecting information from the plan sponsor over the computer network, the information relating to one or more of the plan sponsor's goals for a retirement plan;
providing software on the computer for merging the plan sponsor's one or more goals with retirement plan design;
analyzing the information collected from the plan sponsor using the software; and
generating a group retirement plan with plan rules consistent with the plan sponsor's one or more goals.

60. The method of claim 59 wherein the computer network is accessible to the plan sponsor.

61. The method of claim 59 wherein the one or more goals include to attract and retain employees.

62. The method of claim 59 wherein the one or more goals include minimizing tax liability.

63. The method of claim 59 wherein the one or more goals include benefiting a select group of employees.

64. The method of claim 25 further comprising the step of electronically receiving an application fee from the plan sponsor.

65. The method of claim 47 further comprising the step of electronically receiving an application fee from the plan sponsor.
